(19) United States
(12) Patent Application Publication
(10) Pub. No.: US 2018/0144393 A1
(43) Pub. Date: May 24, 2018

(54) FUEL-EFFICIENT TOOL

(71) Applicants: Jen-Chieh YUAN, Taipei City (TW); Jonah YUAN, Taipei City (TW); Joshua YUAN, Taipei City (TW)

(72) Inventors: Jen-Chieh YUAN, Taipei City (TW); Jonah YUAN, Taipei City (TW); Joshua YUAN, Taipei City (TW)

(21) Appl. No.: 15/551,797

(22) PCT Filed: Feb. 4, 2016
(86) PCT No.: PCT/CN2016/073548

§ 371 Date: Jan. 18, 2018

Related U.S. Application Data
(60) Provisional application No. 62/117,320, filed on Feb. 17, 2015.

(51) Int. Cl. G06Q 30/06; G06Q 10/08

(52) U.S. Cl. CPC G06Q 30/0633; G06Q 10/0875

(57) ABSTRACT

A fuel-efficient tool applicable to a vehicle that delivers goods to a variety of sites is disclosed. A web page generator generates a web page and a plurality of goods items, the web page provided with an input region allowing a driver of the vehicle to input second building-related information. A memory stores some first building-related information corresponding to the goods items for the vehicle to deliver the goods according to the first and second building-related information. A receiver receives the second building-related information. A comparator compares the second building-related information with the plurality of first building-related information. A controller controls the web page generator to generate at least one of the goods items that corresponds to one of the first building-related information that matches the second building-related information such that the vehicle can deliver goods corresponding to the goods item according to the matched first building-related information and have fuel efficiency improved.

### BACKGROUND OF THE INVENTION

### 1. Technical Field

The present invention relates to fuel economy techniques, and, more particularly, to a fuel-efficient tool applicable to a vehicle that delivers goods to a variety of sites.

### 2. Description of Related Art

People can buy goods and ask the store to deliver the goods to the place where he stays, without going to the store in person. Many vehicles are used to deliver goods, including bicycles, motorcycles, cars and drones.

Vehicles deliver goods to a variety of places. Some places, however, are not so crowded that a driver has to drive the vehicle for a long distance to deliver all the goods to these places.

### SUMMARY OF THE INVENTION

A fuel-efficient tool applicable to a vehicle that delivers goods to a variety of sites is provided, an interface generator of the fuel-efficient tool configured for generating an interface and at least one of a plurality of goods items, the interface provided with an input region allowing a driver of the vehicle to input second building-related information, a memory of the fuel-efficient tool configured for storing a plurality of first building-related information corresponding to the goods items for the vehicle to deliver the goods according to the first and second building-related information, a receiver of the fuel-efficient tool configured for receiving the second building-related information input by the driver of the vehicle, a comparator of the fuel-efficient tool electrically connected to the memory and the receiver configured for comparing the second building-related information and the plurality of first building-related information stored in the memory, a controller of the fuel-efficient tool electrically connected to the comparator and the interface generator configured for controlling the interface generator to generate at least one of the goods items that corresponds to one of the plurality of first building-related information that matches the second building-related information such that the vehicle can deliver goods corresponding to the at least one goods item according to the matched first building-related information and have fuel efficiency improved.

A fuel-efficient tool applicable to a vehicle that delivers goods to a variety of sites is also provided, an interface generator of the fuel-efficient tool configured for generating an interface and a goods item, the interface showing only some of all elements contained in a building-related set to allow a driver of the vehicle to select one of the some elements, a receiver of the fuel-efficient tool configured for receiving a selection signal that is generated after the driver of the vehicle selects the one element, a controller of the fuel-efficient tool electrically connected to the interface generator configured for controlling the interface generator to generate the goods item according to the selection signal such that the vehicle can deliver goods corresponding to the goods item according to the selected one element contained in the building-related set and have fuel efficiency improved.

A fuel-efficient tool applicable to a vehicle that delivers goods to a variety of sites is further provided, an interface generator of the fuel-efficient tool configured for generating an interface, the interface showing at least one of a plurality of goods items and only some of all elements contained in a building-related set to allow a driver of the vehicle to select one of the some elements, a receiver of the fuel-efficient tool configured for receiving a selection signal that is generated after the driver of the vehicle selects the one element and for receiving an order that is generated after the selected signal is generated and at least one of the shown at least goods item of the goods items is selected and records goods-related information corresponding to the selected at least one goods item, a delivery event generator of the fuel-efficient tool configured for generating a delivery event that corresponds to the goods-related information and the selected one element of the some elements, a controller of the fuel-efficient tool electrically connected to the receiver and the delivery event generator configured for controlling the delivery event generator to generate the delivery event after the receiver receives the order such that the vehicle can deliver goods corresponding to the selected at least one goods item according to the selected element of the some elements contained in building-related set and have fuel efficiency improved.

### BRIEF DESCRIPTION OF DRAWINGS

The invention can be more fully understood by reading the following detailed description of the preferred embodiments, with reference made to the accompanying drawings, wherein:

FIG. 1 is an illustrative diagram of a fuel-efficient tool of a first embodiment according to the present invention;

FIG. 2 is an illustrative diagram of a fuel-efficient tool of a second embodiment according to the present invention;

FIG. 3 is an illustrative diagram of a fuel-efficient tool of a third embodiment according to the present invention;

FIG. 4 is an illustrative diagram of a fuel-efficient tool of a fourth embodiment according to the present invention; and

FIG. 5 is an illustrative diagram of a fuel-efficient tool of a fifth embodiment according to the present invention.

### DETAILED DESCRIPTION OF THE INVENTION

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

The present invention is provided to save the fuel consumed by a vehicle. With the present invention, the vehicle can have its fuel efficiency improved.

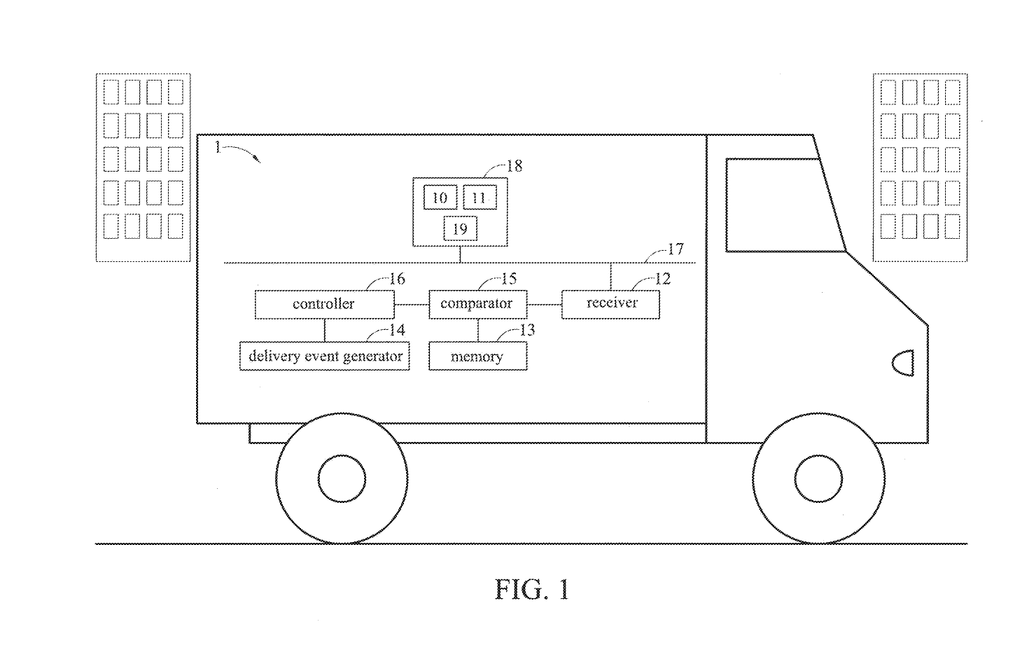

FIG. 1 is an illustrative diagram of a fuel-efficient tool 1 of a first embodiment according to the present invention. The fuel-efficient tool 1 is applicable to a vehicle that delivers goods to a variety of sites, and comprises a receiver 12 receiving an order via a network 17. The order is generated after at least one of one or more goods items (e.g., goods items 10 and 11) shown on an web page 18 of a network product is selected (e.g., clicked), and records goods-related information corresponding to the goods items 10 and 11. A memory 13 is stored with a plurality of client internet protocol (IP) addresses and building-related information corresponding to the IP addresses. A delivery event generator 14 generates a delivery event. A comparator 15 is electrically connected to the memory 13 and the receiver 12, and compares an order IP address corresponding to the order generated due to the ordering of the network product and the client IP addresses stored in the memory 13. A controller 16 is electrically connected to the comparator 15 and the delivery event generator 14, and controls the delivery event generator 14 to generate the delivery event when the order IP address matches one of the client IP addresses, wherein the delivery event relates the goods-related information and building-related information corresponding to the client IP address that matches the order IP address.

In an embodiment, the building-related information is at least one selected from the group consisting of an address and a name of a building, and a name of an organization in the building, wherein the organization is at least one selected from the group consisting of a private company, a government bureau and a non-profit organization.

In an embodiment, the goods-related information is at least one selected from the group consisting of a name, a code, a pattern and an image of goods. In an embodiment, the goods items 10 and 11 correspond to hamburger and sandwich, respectively, and when the goods item 10/11 is clicked, the order records the name, the code, the pattern and/or the image of the hamburger/sandwich.

In an embodiment, the network 17 includes a wired network and a wireless network, the network product includes a computer and a mobile phone, the web page 18 is displayed on the computer and the mobile phone, and the order IP address is the IP address of the computer and the mobile phone. Therefore, a consumer is allowed to use his computer/mobile phone and click the goods items 10 and 11 displayed on the web page 18 to generate the order, and the order will be transmitted via the wired or wireless network to the receiver 12. On the other hand, the comparator 15 compares the IP address of the computer/mobile phone (i.e., the order IP address) with the client IP addresses stored in the memory 13.

In an embodiment, an input region 19 is shown on the web page 18 or another web page displayed on the computer/mobile phone, to request a consumer to login building-related information, including the name or address of a building where the consumer is using his computer/mobile phone, the name of an organization for which he works, or an address that he appoints. The computer/the mobile phone transmits the building-related information via the network 17 to the receiver 12 of the fuel-efficient tool 1. Accordingly, the receiver 12 receives the building-related information and stores the IP address of the computer/mobile phone (i.e., the client IP addresses) and the building-related information via the comparator 15 to the memory 13. In another embodiment, the receiver 12 stores the IP addresses of the computer/mobile phone and the building-related information to the memory 13 directly. Under the latter scenario, the receiver 12 is directly electrically connected to the memory 13. Therefore, the consumer only needs to input the building-related information one time, and can thereafter click the goods items 10 and/or 11, by using the same computer/mobile phone, to buy the goods that the goods items 10 and/or 11 correspond to.

In an embodiment, the delivery event is generating a delivery list, which records the goods-related information and building-related information corresponding to the client IP address that matches the order IP address. Therefore, even if the consumer does not input his address, the delivery list will still records the address (or the name of the building or the name of the organization) that the consumer inputs previously when logging in his computer/mobile phone, and a delivery unit can deliver the goods ordered by the consumer to the address according to the delivery list. In another embodiment, the delivery list further records a date, which is later than the date when the receiver 12 receives the order by at least one day. In order to save a delivery cost, the goods ordered by the consumer will be delivered to the appointed address one day later than the date when the consumer ordered the goods (i.e., clicks the goods items 10 and 11). In other words, the fuel-efficient tool 1 does not deliver the goods as soon as the order is generated. In an embodiment, the fuel-efficient tool 1 does not deliver the goods until the amount of the goods exceeds a predetermined threshold, especially all the orders corresponding to the same building-related information (e.g., the orders are generated by different consumers working at the same office building).

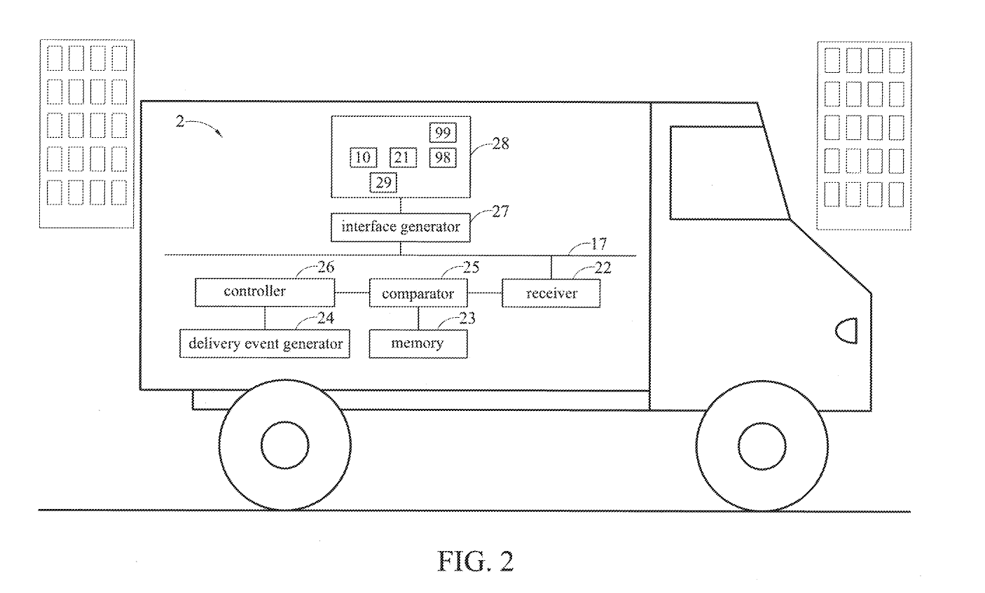

FIG. 2 is an illustrative diagram of a fuel-efficient tool 2 of a second embodiment according to the present invention. The fuel-efficient tool 2 comprises an web page generator 27 that generates an web page 28. On the web page 28 are shown an input region 29, one or more goods items (e.g., goods items 20 and 21), and delivery time 98 corresponding to the goods items 20 and 21. A receiver 22 receives an order via the network 17. The order is generated after at least one of the goods items 20 and 21 shown on the web page 28 is selected and second building-related information is input to the input region 29. The order records goods-related information corresponding to the goods items 20 and 21, and the second building-related information. A comparator 25 is electrically connected to the receiver 22 and compares order time when the receiver 22 receives the order and the delivery time 98. A delivery event generator 24 generates a delivery event. The delivery event relates the goods-related information and the second building-related information. A controller 26 is electrically connected to the comparator 25 and the delivery event generator 24 and controls the delivery event generator 24 to generate the delivery event if the order time is earlier than the delivery time 98 by a predetermined time length.

In an embodiment, the web page 28 also shows order cutoff time 99, which is equal to the delivery time 98 deducted by the predetermined time length. Therefore, a consumer has to click at least one of the goods items 20 and 21 before the order cutoff time 99, or the delivery event generator 24 will not generate the delivery event.

In an embodiment, the fuel-efficient tool 2 further comprises a memory 23 electrically connected to the comparator 25 for storing a plurality of first building-related information. The comparator 25 further compares the second building-related information with the first building-related information stored in the memory 23. The controller 26 will not control the delivery event generator 24 to generate the delivery event unless the second building-related information matches one of the first building-related information. In another embodiment, the first building-related information stored in the memory 23 is selected purposely, such as a building in which a great number of workers work. In other words, the fuel-efficient tool 2 only receives orders from a building in which a great number of worker works. Therefore, a great number of goods can be delivered to the same address at the same time, and the vehicle can consume less fuel.

In an embodiment, the first building-related information and the second building-related information are at least one selected from the group consisting of an address and a name of a building, and a name of an organization in the building.

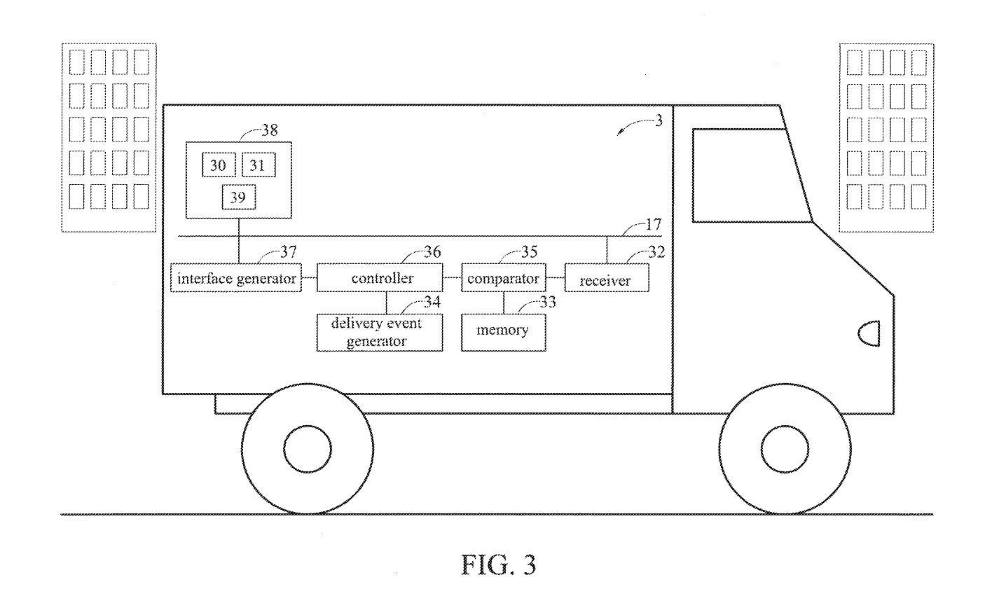

FIG. 3 is an illustrative diagram of a fuel-efficient tool 3 of a third embodiment according to the present invention. The fuel-efficient tool 3 comprises an web page generator 37 for generating an web page 38 and at least one of a plurality of goods items (e.g., goods items 30 and 31). The web page 38 has an input region 39. A memory 33 is stored with a plurality of first building-related information corresponding to the goods items 30 and 31. A receiver 32 receives via the network 17 second building-related information input to the web page 38 within the input region 39. A comparator 35 is electrically connected to the memory 33 and the receiver 32 for comparing the second building-related information and the first building-related information. A controller 36 is electrically connected to the comparator 35 and the web page generator 37 for controlling the web page generator 37 to generate goods items of the goods items 30 and 31 that correspond to the first building-related information when the second building-related information matches one of the first building-related information.

In an embodiment, the first building-related information and the second building-related information are at least one selected from the group consisting of an address and a name of a building, and a name of an organization in the building.

In an embodiment, the goods items 30 and 31 correspond to hamburger and sandwich, respectively, and to addresses A and B, respectively; if the second building-related information input to the input region 39 of the web page 38 is the address A, the controller 36 controls the web page generator to generate the goods items 30 only, without generating the goods items 31. Therefore, consumers stayed in different buildings or addresses, or working in different companies will see different goods items on their computers or mobile phones.

In an embodiment, the fuel-efficient tool 3 further comprises a delivery event generator 34 electrically connected to the controller 36 for generating a delivery event. The receiver 32 further receives an order via the network 17. The order is generated after the at least one of the goods items 30 and 31 generated by the web page generator 37 is selected. The order records goods-related information corresponding to the at least one of the goods items 30 and 31. The controller 36 further controls the delivery event generator 34 to generate the deliver event after the receiver 32 receives the order. The delivery event corresponds to goods-related information corresponding to the at least one of the goods items 30 and 31, and the second building-related information.

In an embodiment, the delivery event is generating a delivery list. The delivery list records the goods-related information corresponding to the at least one of the goods items 30 and 31, and the second building-related information.

In an embodiment, the goods items 30 and 31 generated by the web page generator 37 can be displayed on the web page 38, or displayed on another interface.

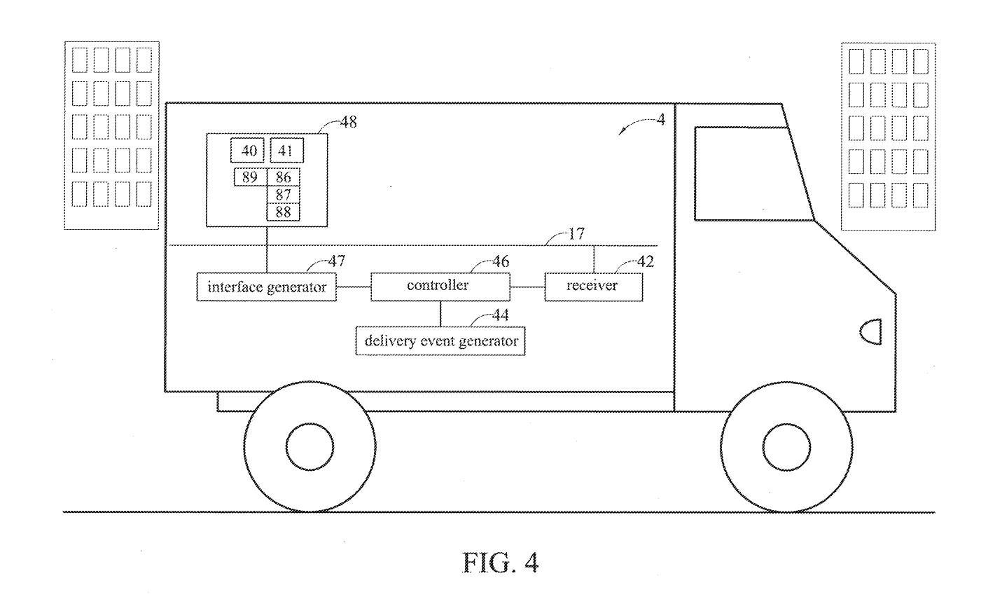

FIG. 4 is an illustrative diagram of a fuel-efficient tool 4 of a fourth embodiment according to the present invention. The fuel-efficient tool 4 is applicable to a vehicle that delivers goods to a variety of sites, and comprises an web page generator 47 for generating an web page 48 and goods items (e.g., goods items 40 and 41). Some (not all) element 86-88 of all elements contained in a building-related set 89 are displayed on the web page 48. A receiver 42 receives a selection signal. The selection is generated after one of the some elements 86-88 is selected by, for example, the driver of the vehicle or the user of the computer/mobile phone. A controller 46 is electrically connected to the web page generator 47 and the receiver 42 for controlling the web page generator 47 to generate the goods items 40 and 41 according to the selection signal.

In an embodiment, the web page 47 further displays the building-related set 89.

In an embodiment, the building-related set 89 is an area, the all elements are all streets within the area, and the some elements are some streets of the all streets. In an embodiment, the building-related set 89 is city C, and the all elements are all streets in city C, including streets a-d. In another embodiment, the building-related set 89 is a street, the all elements are all addresses in the street, and the some elements are some addresses of the all addresses. In yet another embodiment, the building-related set 89 is street a, and the all elements are all addresses, e.g., nos. 1-100, in street a.

In an embodiment, the web page generator 47 only generates some elements 86-88 of all elements contained in the building-related set 89. In an embodiment, the building-related set 89 is city C, the all elements are streets a-d, and the web page generator 47 generates street a 86, street b 87 and street d 88 only. In another embodiment, the building-related set 89 is street a, the all elements are nos. 1-100, and the web page generator 47 generates no. 3 86, no. 18 87, and no. 72 88 only. The reason why the web page generator 47 generates only the some elements 86-88 of the all elements contained in the building-related set 89 according to the present invention is that only the some elements 86-88 (e.g., street a 86, street b 87 and street d 88 in city C, or no. 3 86, no. 18 87, and no. 72 88 in street a) are stood with buildings in which a great number of worker works. The present invention selects these buildings purposely as the destination for the delivered goods. Therefore, the vehicle can have its fuel efficiency improved.

In an embodiment, the building-related set 89 is a letter, and the all elements are building or organization names that contain the letter. In another embodiment, the building-related set 89 is “a”, the all elements are “Apple,” “Maple,” “Staple” and “Honda,” and the web page generator 47 generates Apple 86, Staple 87 and Honda 88 only. Therefore, only the workers of Apple 86, Staple 87 and Honda 88 can use the fuel-efficient tool 4 to buy goods.

In an embodiment, the receiver 42 further receives an order via the network 17. The order is generated after at least one of the goods items 40 and 41 is selected. The order records goods-related information corresponding to the at least one of the goods items 40 and 41. The fuel-efficient tool 4 further comprises a delivery event generator 44 electrically connected to the controller 46 for generating a delivery event. The delivery event relates the goods-related information and the one of the some elements 86-88. The controller 46 further controls the delivery event generator 44 to generate the delivery event after the receiver 42 receives the order.

In an embodiment, the delivery event is generating a delivery list. The delivery list records the goods-related information and the one of the some elements 86-88. In another embodiment, the delivery list further records the building-related set 89. In yet another embodiment, the delivery list records “hamburger” and “street a no. 3.”

In an embodiment, the goods items 40 and 41 generated by the web page generator 47 can be displayed on the web page 48, or displayed on another interface.

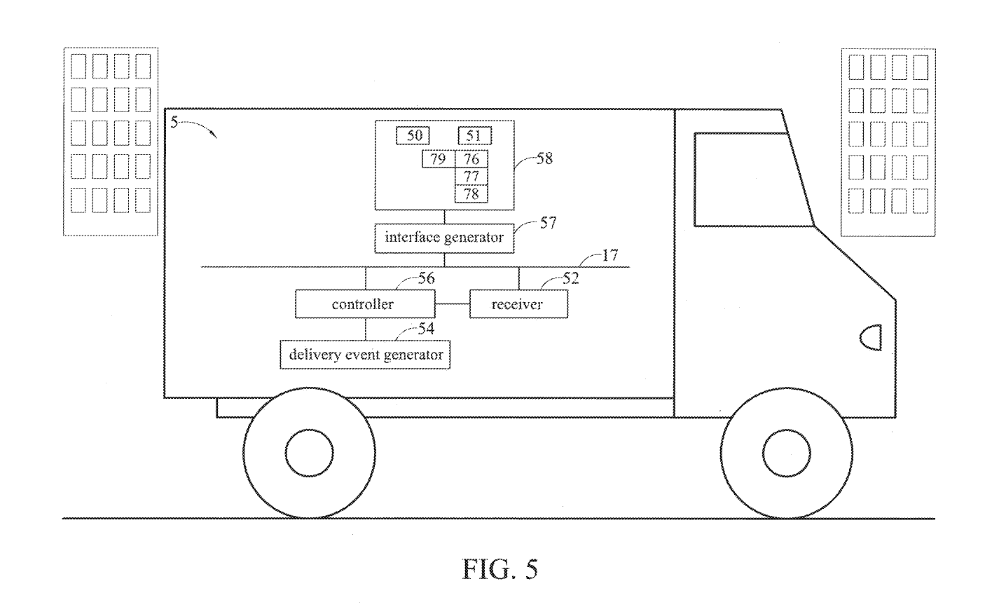

FIG. 5 is an illustrative diagram of a fuel-efficient tool 5 of a fifth embodiment according to the present invention. The fuel-efficient tool 5 comprises an web page generator 57 for generating an interface. The web page shows goods items 50 and 51 and only some elements 76-78 of all elements contained in the building-related set 79. A receiver 52 receives via the network 17 a selection signal and an order. The selection signal is generated after one of the some elements 76-78 is selected. The order is generated after the selection signal is generated and at least one of the goods items 50 and 51 is selected. The order records goods-related information corresponding to the at least one of the goods items 50 and 51. A delivery event generator 54 generates a delivery event. The delivery event relates the goods-related information and the one of the some elements 76-78. A controller 56 is electrically connected to the receiver 52 and the delivery event generator 52 for controlling the delivery event generator 54 to generate the delivery event after the receiver 52 receives the order.

In an embodiment, the building-related set is an area, the all elements are all streets in the area, and the some elements are some streets of the all streets. In another embodiment, the building-related set is a street, the all elements are all addresses in the street, and the some elements are some streets of the all streets. In yet another embodiment, the building-related set is a letter, and the all elements are all building or organization names containing the letter.

In an embodiment, the web page 58 further displays the building-related set 79.

In an embodiment, the delivery event is generating a delivery list. The delivery list records the goods-related information and the one of the some elements 76-78. In another embodiment, the delivery list further records the building-related set 79.

Although the present invention is described by first to fifth embodiments individually, all the components and mechanisms described in these embodiments can be integrated in one embodiment, as long as their functions do not conflict. In an embodiment, the mechanisms of comparing the order IP address with the client IP addresses, comparing the delivery time with the order time and comparing second building-related information with first building-related information described in the first to third embodiments, respectively, can be applied to the fourth and fifth embodiments.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

1. A fuel-efficient tool applicable to a vehicle that delivers goods to a variety of sites,
a web page generator of the fuel-efficient tool configured for generating a web page and at least one of a plurality of goods items, the web page provided with an input region allowing a driver of the vehicle to input second building-related information,
a memory of the fuel-efficient tool configured for storing a plurality of first building-related information corresponding to the goods items for the vehicle to deliver the goods according to the first and second building-related information;
a receiver of the fuel-efficient tool configured for receiving the second building-related information input by the driver of the vehicle,
a comparator of the fuel-efficient tool electrically connected to the memory and the receiver configured for comparing the second building-related information with the first building-related information stored in the memory, and
a controller of the fuel-efficient tool electrically connected to the comparator and the web page generator configured for controlling the web page generator to generate at least one of the goods items that corresponds to one of the first building-related information when the second building-related information matches the one of the first building-related information such that the vehicle can deliver goods corresponding to the at least one goods item according to the matched first building-related information and have fuel efficiency improved.

2. The fuel-efficient tool of claim 1, wherein the first building-related information and the second building-related information are at least one selected from the group consisting of an address and a name of a building and a name of an organization in the building.

3. (canceled)

4. (canceled)

5. A fuel-efficient tool applicable to a vehicle that delivers goods to a variety of sites,
a web page generator of the fuel-efficient tool configured for generating a web page and a goods item, the web page showing only some of all elements contained in a building-related set to allow a driver of the vehicle to select one of the some elements,
a receiver of the fuel-efficient tool configured for receiving via a network a selection signal that is generated after the driver of the vehicle selects the one element,
a controller of the fuel-efficient tool electrically connected to the web page generator configured for controlling the web page generator to generate the goods item based on the selection signal such that the vehicle can deliver goods corresponding to the goods item according to the selected one element contained in the building-related set and have fuel efficiency improved.

6. The fuel-efficient tool of claim 5, wherein the building-related set refers to an area, and the all elements refer to all streets in the district.

7. The fuel-efficient tool of claim 5, wherein the building-related set refers to a street, and the all elements refer to all addresses in the street.

8-13. (canceled)

14. A fuel-efficient tool applicable to a vehicle that delivers goods to a variety of sites,
a web page generator of the fuel-efficient tool configured for generating a web page that shows at least one of a plurality of goods items and only some of all elements contained in a building-related set to allow a driver of the vehicle to select one of the some elements,
a receiver of the fuel-efficient tool configured for receiving via a network a selection signal that is generated after the driver of the vehicle selects the one element and for receiving an order that is generated after the selected signal is generated and at least one of the shown at least goods item of the goods items is selected and records goods-related information corresponding to the selected at least one goods item,
a delivery event generator of the fuel-efficient tool configured for generating a delivery event that corresponds to the goods-related information and the one of the some,
a controller of the fuel-efficient tool electrically connected to the receiver and the delivery event generator configured for controlling the delivery event generator to generate the delivery event after the receiver receives the order such that the vehicle can deliver goods corresponding to the selected at least one goods item according to the selected element of the some elements contained in building-related set and have fuel efficiency improved.

15. The fuel-efficient tool of claim 14, wherein the building-related set is an area, and the all elements refer to all streets in the area.

16. The fuel-efficient tool of claim 14, wherein the building-related set refers to a street, and the all elements refer to all addresses in the street.

17-20. (canceled)
